(19) United States
(12) Patent Application Publication
(10) Pub. No.: US 2007/0036279 A1
(43) Pub. Date: Feb. 15, 2007

(54) PERSONAL NOTIFICATION AND BROADCASTING

(76) Inventors: Kenneth C. Tam, Carmel, CA (US); Alan A. Larson, Scottsdale, AZ (US); Dan Melchione, San Diego, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/423,404

(22) Filed: Jun. 9, 2006

Related U.S. Application Data
(63) Continuation-in-part of application No. 11/423,092, filed on Jun. 8, 2006.
(60) Provisional application No. 60/689,705, filed on Jun. 9, 2005.
(60) Provisional application No. 60/730,603, filed on Oct. 26, 2005.

(51) Int. Cl. H04M 11/04

(52) U.S. Cl. 379/45; 379/88.23

(57) ABSTRACT

While various communication systems permit one-on-one communication between users, it is difficult to contact multiple users at a time with little hassle. The personal notification and broadcasting system provides a solution for contacting a plurality of contacts in emergency and non-emergency contexts. The system receives a call from a caller attempting to reach the plurality of contacts. The system compares an identifier associated with the caller to identifiers stored in a database to authenticate identity of the caller. Responsive to a positive authentication of the identity of the caller, the system identifies which contacts on a contact list to be reached based on information provided by the caller. In some embodiments, the system retrieves from a database stored contact information for the identified contacts. The system contacts the identified plurality of contacts and selects an action to take (e.g., arranging a conference call, broadcasting a message from the caller, etc.) from a one or more actions, wherein the action to take is selected based on the identifier.

### CROSS-REFERENCE TO RELATED APPLICATIONS

This application is a continuation-in-part of U.S. patent application Ser. No. 11/423,092, filed Jun. 8, 2006, entitled “Personal Notification and Broadcasting,” and also claims the benefit of U.S. Provisional Application No. 60/689,705, filed on Jun. 9, 2005, entitled “Personal Alarm/Alerting System,” and claims the benefit of U.S. Provisional Application No. 60/730,603, filed on Oct. 26, 2005, entitled ” Personal Alarm/Alerting System,” the entire disclosures of which are all hereby incorporated by reference herein, including any appendices or attachments thereof, in their entirety for all purposes.

### BACKGROUND OF THE INVENTION

1. Field

This invention pertains in general to a notification system, and more specifically to a notification and broadcasting system for simultaneously contacting multiple users.

2. Description of the Related Art

With the evolution of current communication systems, it is becoming more and more important to users to be able to very quickly and efficiently contact multiple persons at a time. While various communication systems permit one-on-one communication between users, it is more difficult to rapidly get out a message to or quickly arrange a conference call with multiple users at a time with little hassle.

One situation in which a user may need to very quickly reach multiple people is when the user is in danger or otherwise encounters an emergency situation. In particular, the user may need to contact multiple family and friends at a time that are located nearby. A third of all child abduction/murders happen within 200 feet of the child's home. Most college campus rapes happen in student housing. Commonly, the person in danger first calls 9-1-1. However, the average response time for 9-1-1 nationwide is over 5 minutes. Had a nearby family, friend, classmate, neighbor, etc. been contacted, they may have been able to respond in seconds, greatly increasing the chances of saving the person in danger.

Even when an emergency is not at hand, there are still many other situations in which a user may need to contact multiple persons at a time. In a corporate environment, arranging a conference call can sometimes be a hassle. Commonly, there must be a dial-in number and PIN that must be sent to all participants in the call, and these participants must be relied upon not to lose this number or PIN or otherwise have technical difficulties in dialing the number and connecting to the call. Some participants may enter the call late and they must again be able to locate the dial-in number and connect themselves to the call after it has already begun.

Therefore, there is a need for a solution that allows a user to contact multiple people at a time with minimal delay and hassle.

### SUMMARY

The above need is met by system for contacting a plurality of contacts in emergency and non-emergency contexts. The system receives a call from a caller attempting to reach the plurality of contacts. The system compares an identifier automatically associated with the caller to identifiers stored in a database to authenticate identity of the caller. Responsive to a positive authentication of the identity of the caller, the system identifies which group of contacts on a contact list to be reached based on information provided by the caller. In some embodiments, the system retrieves from a database stored contact information for the identified contacts. The system contacts the identified group of contacts and selects an action to take from one or more actions, where the action to take is selected based on the identifier. For example, the system can place the caller into contact with the identified group of contacts through a conference call, can broadcast a message to the contacts (e.g., a message from the caller 102 that is pre-recorded in advance, or recorded at the time of the call, etc.), or can take another action.

The features and advantages described in this disclosure and in the following detailed description are not all-inclusive, and particularly, many additional features and advantages will be apparent to one of ordinary skill in the relevant art in view of the drawings, specification, and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTION OF THE DRAWINGS

FIG. 1 is a high-level block diagram illustrating the notification and broadcasting system, according to one embodiment of the present invention.

FIG. 2 is a high-level block diagram illustrating the functional modules within the host system, according to one embodiment of the present invention.

FIG. 3 is a high-level block diagram illustrating an example of the host system 104 operating in an emergency situation, according to one embodiment of the present invention.

FIG. 4 is a flowchart illustrating the process by which a user can sign up to use a service associated with the system, according to one embodiment of the present invention.

FIG. 5 is a flowchart illustrating the operation of the system 100 in contacting the user's contacts in the context of an emergency, according to one embodiment of the present invention.

FIG. 6 is a flowchart illustrating the operation of the system in contacting the user's contacts in the context of a non-emergency situation, according to one embodiment of the present invention.

The figures depict an embodiment of the present invention for purposes of illustration only. One skilled in the art will readily recognize from the following description that alternative embodiments of the structures and methods illustrated herein may be employed without departing from the principles of the invention described herein.

### DETAILED DESCRIPTION

The system allows a user to simultaneously contact multiple friends, family members, neighbors, co-workers, etc. In some embodiments, these multiple contacts can be reached with one touch of a phone button, and the system can work on any phone and can contact any type of phone. In some embodiments, the system can also generate multiple, simultaneous short messaging system (SMS), e-mail, instant messages (IM), etc. to a set of contacts identified by the user. In some embodiments, users sign up to use the system via the Internet, where the user can enter and manage a set of contacts on-line. The user can enter contact information for each of the friends, family members, co-workers, neighbors, etc., including names, e-mail addresses, work/home/mobile phone numbers, addresses, description of the contact, relationship to the contact, and other relevant information. In some embodiments, the user is provided with a general contact number for the host system. The user can load this number into the speed dial directory on their phone (or in the phone book or other location within the phone), and thus the user can reach all of his/her contacts simultaneously by pressing the speed dial number. This can be useful in an emergency situation where a user needs to immediately contact persons who might be able to help, and preferably are nearby the incident. This can also be useful in rapidly setting up a general conference call with a number of individuals. For example, a team manager in a corporate environment might wish to have all of her team members' contact information entered into the system so that the manager can easily and quickly be put into contact with the entire team. As another example, a user might set up a speed dial number such that the user can immediately be placed into contact with particular family members, friends, etc.

The system can also be designed to authenticate the user by recognizing the user's phone number via caller ID, by using automatic number identification, or via some other type of identifier. In this manner, the system can determine who the user is and ensure that the call is not a prank. In addition, by recognizing the user automatically (without requiring the user to speak), the call by the user can be silent if needed (e.g., in an emergency situation where a user cannot speak).

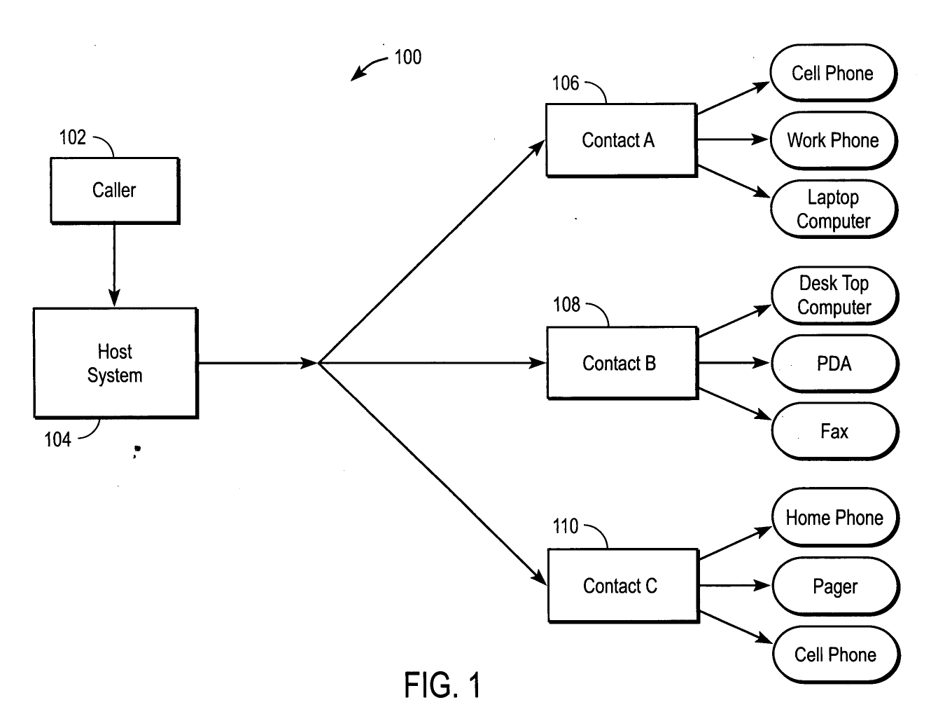

FIG. 1 is a high-level block diagram illustrating the notification and broadcasting system 100, according to some embodiments of the present invention. In some embodiments, the system 100 includes a host system 104 that receives a call from a caller 102. The caller 102 can contact each of a plurality of contacts by contacting the host system 104, which can act as a connection point between the caller 102 and a plurality of contacts (contact A 106, contact B 108, and contact C 110). The host system 104 can be a web server, a calling service, or some other type of system for receiving calls or other types of messages. In some embodiments, the host system 104 includes various types of contact information for the contacts 106, 108, 110. For example, the host system 104 can store mobile phone numbers, home phone numbers, work phone numbers, fax numbers, pager numbers, e-mail addresses, and so forth.

In response to receiving a call, the host system 104 can call or send a message to the contacts 106, 108, 110 via phone (landlines and mobile phones, including via home, work, cell numbers, etc.), via the contact's personal digital assistant (PDA), smart-phone, computer (e.g., laptop, desk top, etc.), pager, fax machine and so forth. In some embodiments, the system 104 can put the caller 102 into contact with the contacts 106, 108, 110 through a conference call or some other contact mechanism, or the system 104 can transfer a message from the caller 102 to the contacts 106, 108, 110, and so forth. Thus, the host system 104 can reach the contacts 106, 108, and 110 via e-mail, text message or short message service (SMS) message, instant message (IM), voice-over-Internet protocol message (VoIP), fax, voice message, page, conference call, and the like. While FIG. 1 illustrates three contacts 106, 108, 110, the number of contacts that the caller 102 can reach can be substantially larger (e.g., 10 contacts, 50 contacts, 100 contacts, etc.). A contact or contacts can include persons, systems, computers, servers, software applications, and the like.

As is known in the art, the computer system 200 is adapted to execute computer program modules for providing functionality described herein. In this description, the term “module” refers to computer program logic for providing the specified functionality. A module can be implemented in hardware, firmware, and/or software. Where the any of the modules described herein are implemented as software, the module can be implemented as a standalone program, but can also be implemented in other ways, for example as part of a larger program, as a plurality of separate programs, or as one or more statically or dynamically linked libraries. It will be understood that the modules described herein represent one embodiment of the present invention. Certain embodiments may include other modules. In addition, the embodiments may lack modules described herein and/or distribute the described functionality among the modules in a different manner. Additionally, the functionalities attributed to more than one module can be incorporated into a single module.

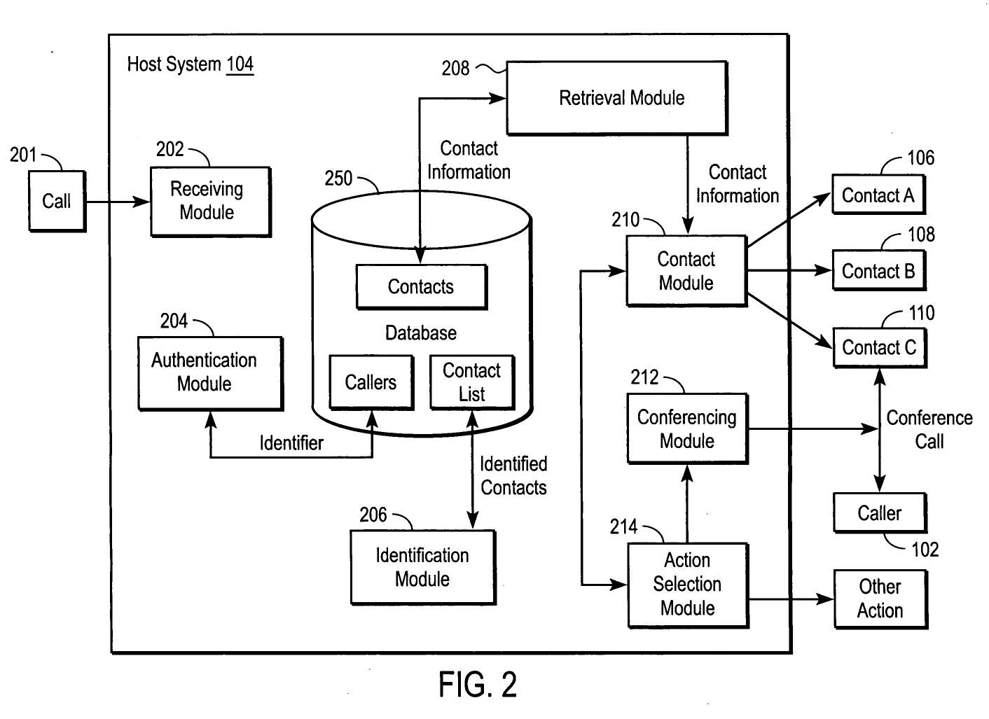

FIG. 2 is a high-level block diagram illustrating the functional modules within the host system 104, according to one embodiment of the present invention. The host system 104, in the embodiment illustrated in FIG. 2, includes a receiving module 202, an authentication module 204, an identification module 206, a contact module 210, and an action selection module 214. In some embodiments, the host system 104 further includes a retrieval module 208, conferencing module 212, and a database 250. Those of skill in the art will recognize that other embodiments can have different and/or additional modules or components than those shown in FIG. 2 and the other figures. Likewise, the functionalities can be distributed among the modules/components in a manner different than described herein. When describing the embodiments of the invention below, the examples frequently focus on examples involving an emergency situation. However, throughout the specification, the examples used also apply to situations (e.g., arranging a corporate conference call, a conference call with friends, etc.) as previously described.

The receiving module 202 receives a call 201 from a caller 102 attempting to reach the plurality of contacts (e.g., contacts 106, 108, and 110). As described above, the call 201 can be a phone call (via mobile or landline). In some embodiments, the receiving module 202 receives a message or other type of communication from the caller 102 (e.g., an e-mail, a text message, a fax, and the like). In some embodiments, the caller 102 can pre-program his or her phone (e.g., home phone or mobile phone) to be able to automatically contact the host system 104 quickly. For example, the phone number for reaching the host system 104 can be programmed into the phone as a speed dial number that the caller 102 can press to reach the host system 104.

The authentication module 204 compares an identifier associated with the caller 102 to identifiers stored in a database 250 to authenticate identity of the caller 102. In some embodiments, the host system 104 can keep track of callers 102 by storing information associated with those callers 102 in a database 250. For example, the host system 104 might be designed to recognize callers 102 that are registered with the host system 104 or are subscribers to a service associated with the host system 104. In this example, the caller 102 may have signed up or registered in advance for a service associated with the host system 104 that allows the caller 102 to reach contacts 106, 108, 110 via the host system 104. In this example, the host system 104 might store an identifier associated with each registered caller 102 in the database 250, such as the phone number for the phone from which the caller 102 is calling, a PIN number or ID number assigned upon registration, or other identifier. One or more of these identifiers can then be used to authenticate the identity of the caller 102. The module 204 can also compare an identifier that is automatically associated with the caller 102. Thus, the caller 102 does not have to type in a password or PIN number, but instead the host system 104 automatically recognizes who the caller is. For example, the authentication module 204 can use caller ID or automatic number ID (identifiers that are automatically associated with the caller 102) to recognize the caller 102 and then can compare this number to a collection of registered numbers stored in the database 250.

The identification module 206 identifies which group of contacts on a contact list to be reached based on information provided by the caller 102. In some embodiments, the caller 102 has identified in advance which contacts should be reached or has identified groups of contacts. A group of contacts includes two or more contacts. The caller 102 can provide contact information for each of the contacts (including name, mobile, work, home, or pager number, other contact numbers, e-mail addresses, and the like). In some embodiments, the contact information for the contacts 106, 108, 110 is stored by the host system in some type of storage, such as in database 250. In some embodiments, the caller 102 can identify in advance which contacts should be contacted at what times of day, days of week, etc. (e.g., the caller 102 has set up groups of contacts based on time of day or day of week), and thus the module 206 can restrict who to contact based on a set of rules. For example, where the system 100 is used as an emergency alert system, the caller 102 might set up a contact list in which the caller's 102 neighbors are contacted in the evenings when the caller 102 is likely at home (and thus the emergency has occurred at home), while the caller's 102 co-workers are contacted during the day time when the caller 102 is likely at work. In addition, the caller 102 might specify that on weekends, certain family members and friends are contacted, as opposed to different family members and friends on the weekdays (e.g., the weekend group or the weekday group). Thus, if the system 100 is designed so that the caller 102 can press a speed dial button to be connected with the host system 104 in an emergency, the identification module 206 can review the caller's 102 contact list in database 250 to determine what contacts should be called at that time of day/day of week. The host system 104 can then put the caller 102 into contact with those persons, can e-mail them, send a text message to them, and so forth (or any combination of these contact methods).

As another example, in the corporate context where the system 100 is used to set up conference calls with co-workers, the contact list might include different groups of team members (e.g., the product A development team, the product B development team, etc.). In this example, the system 100 might be designed so that the caller 102 can press different speed dial buttons, enter in a code, and so forth. Upon indicating the team to be contacted, the host system 104 can place the caller 102 immediately into conference with those team members (and/or send them an e-mail, text message, etc.).

In some embodiments, the system 100 can also be designed so that the caller 102 can identify which numbers each of his contacts on his contact list ought to be reached at, and possibly identify different numbers to be used at different times of day. For example, on weekdays, during the daytime, the host system 104 might contact identified family, friends, co-workers, product development teams or other groups, etc. on their work phone numbers, work e-mail addresses, and the like. In the evenings and on weekends, the host system 104 might contact the identified contacts on home numbers, mobile phone numbers, home e-mail addresses, and so forth.

In some embodiments, the call 201 is only allowed to proceed upon authentication of the caller 102 by the authentication module 204. So, the identification step occurs responsive to a positive authentication of the identity of the caller 102.

As described above, the module 206 identifies which group of contacts (e.g., product development team A, weekend group of family/friends, weekday group of contacts, weekday/nighttime group of contacts, and so forth) on a contact list to be reached based on information provided by the caller 102. In some embodiments, the information provided by the caller 102 is the information the caller 102 provided in advance (e.g., the designated groups set up by the caller 102 and the contact information that the caller 102 has provided for these groups). Thus, module 205 can determine which group to call using this advance-provided information based on what button on the phone the caller 102 presses (e.g., #5 for all contacts, #4 for weekend contacts, etc.) or if the caller 102 has identified only one group, the module 205 identifies which group to be reached based on the caller's 102 phone number (e.g., the group to call is implied since there is only one group).

The optional retrieval module 208 can retrieve contact information for identified contacts from the database. In some embodiments, the module 208 can retrieve from the database 250 the contact information needed to reach the contacts that the identification module 206 identified ought to be reached. For example, if the identification module 206 identified that the product development team A is to be contacted by work phone number, the module 208 can retrieve work phone numbers for each of those team members. As another example, the retrieval module 208 might retrieve information for the weekday/nighttime family, friends, and neighbors emergency contact list.

The contact module 210 contacts the identified group of contacts. The contact module 210 can contact each of the persons identified by the identification module 206 using the provided contact information. The module 210 might make a phone call to each of the identified contacts via one or more contact numbers or some other action can be taken as determined by the action selection module 214 (described below).

The action selection module 214 selects an action to take from one or more actions, wherein the action to take is selected based on the identifier. For example, the action selected can be arranging a conference call between the caller 102 and the contacts, broadcasting a message from the caller 102 to the contacts (e.g., a message that the caller 102 pre-recorded or a message recorded in real time when the caller 102 makes the call), or other action. As other examples, the action selected can include sending an e-mail, text message, fax, page, or other type of message to the contacts. The action that the module 214 selects is based upon the identifier (e.g., the caller's 102 phone number that is recognized through caller ID, automatic number identification, etc.) associated with the caller. For example, the module 214 can recognize the caller's 102 phone number, and using this information, the module 214 can select which action to be taken (e.g., based on preferences the caller 102 set up in advance). Thus, based on the phone number, the module 214 can determine that the caller 102 should be placed into conference with his contacts, that a particular message should be sent to the contacts, that e-mails should be sent to the contacts, etc. The caller 102 does not need to speak to an operator to state the actions he would like performed because these can be automatically performed based on the identifier.

In some embodiments, where the action selected is a arranging a conference call, the conferencing module 212 places the caller 102 into contact with each of the identified plurality of contacts through a conference call. Where the caller 102 has identified that the contacts should be reached via phone and that a conference call should be arranged, the module 212 can place the caller into conference with the identified contacts. In this embodiment, a conference call is a call in which a conferencing bridge is established between the caller and the contacts allowing the caller and contacts to participate in (e.g., to speak, listen in on, etc.) the call at the same time. For example, in a corporate environment, the caller 102 might indicate that he/she would like to be placed into conference with a particular contact list (e.g., the hiring team, the management team, the product development team, another identified group of co-workers, etc.) and the module 212 can immediately place that caller 102 into conference with the members of that contact list. As another example, the caller 102 might indicate a list of family members or friends with whom a conference call should be arranged. In some embodiments, the caller 102 can be placed into conference with the contacts very rapidly (e.g., 5 seconds, 10 seconds, 20 seconds 30 seconds, 60 seconds, 2 minutes, and the like).

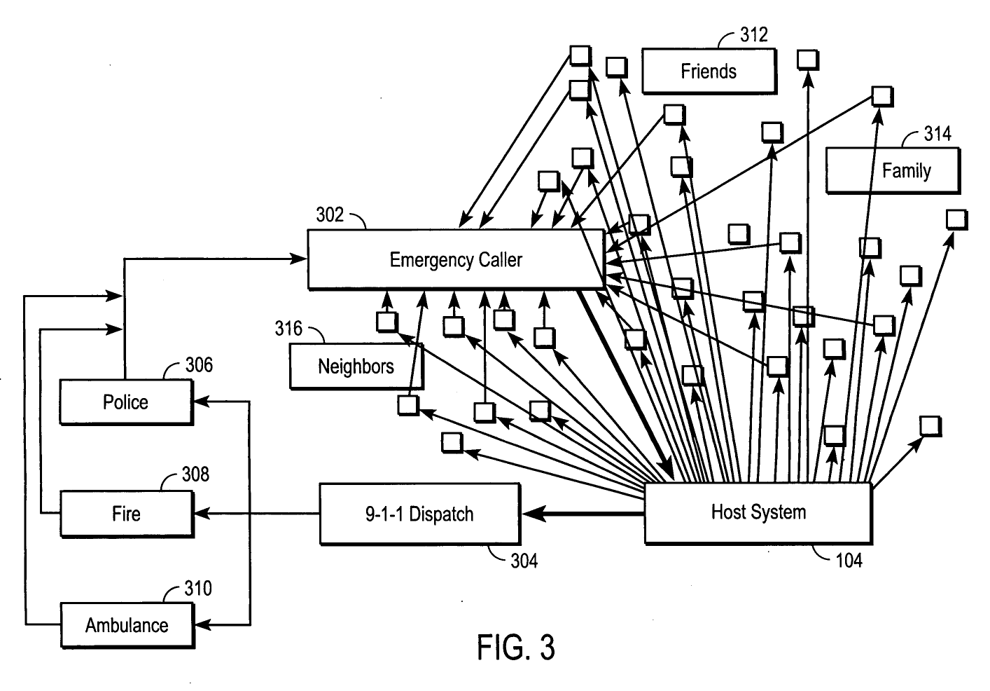

Referring now to FIG. 3, there is shown a diagram illustrating an example of the host system 104 operating in an emergency situation, according to some embodiments of the present invention. An emergency situation can include any situation in which the caller 102 feels threatened, including where an intruder has entered the caller's 102 home, where a caller 102 is being threatened in a public location or other location, where the caller 102 is injured (or someone near the caller 102 is injured), where a there is a fire, and so forth. FIG. 3 illustrates an emergency caller 302 that has made a call or otherwise contacted the host system 104. The host system 104 can then respond both by contacting 9-1-1 dispatch 304 and by contacting a number of contacts on a contact list (e.g., friends, family, neighbors, etc.). As described above, the caller 102 might have identified in advance which persons should be contacted at particular times of day/days of week, and which contact information should be used (e.g., phone, e-mail, text message, VoIP, IM, etc.). The 9-1-1 dispatch can also contact the police 306, fire department 308, ambulance 310, and other emergency services as necessary. Thus, rather than just putting out a call to 9-1-1, the host system 104 also contacts numerous people that might even be in the area of the caller 302 who could potentially respond to the emergency much more quickly than the emergency dispatch 304.

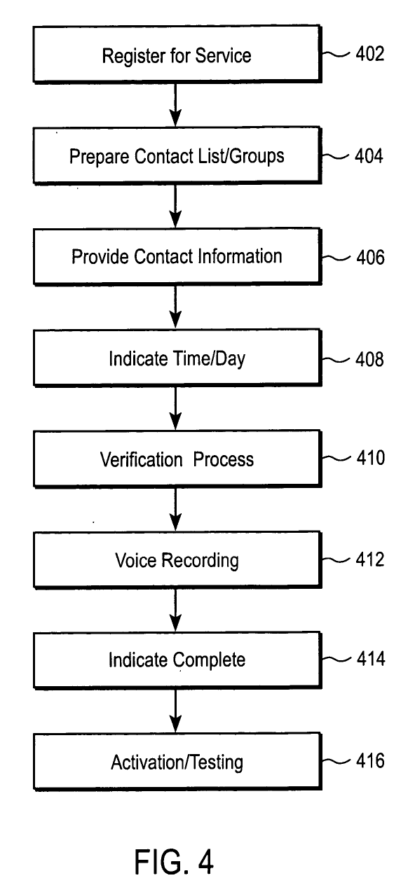

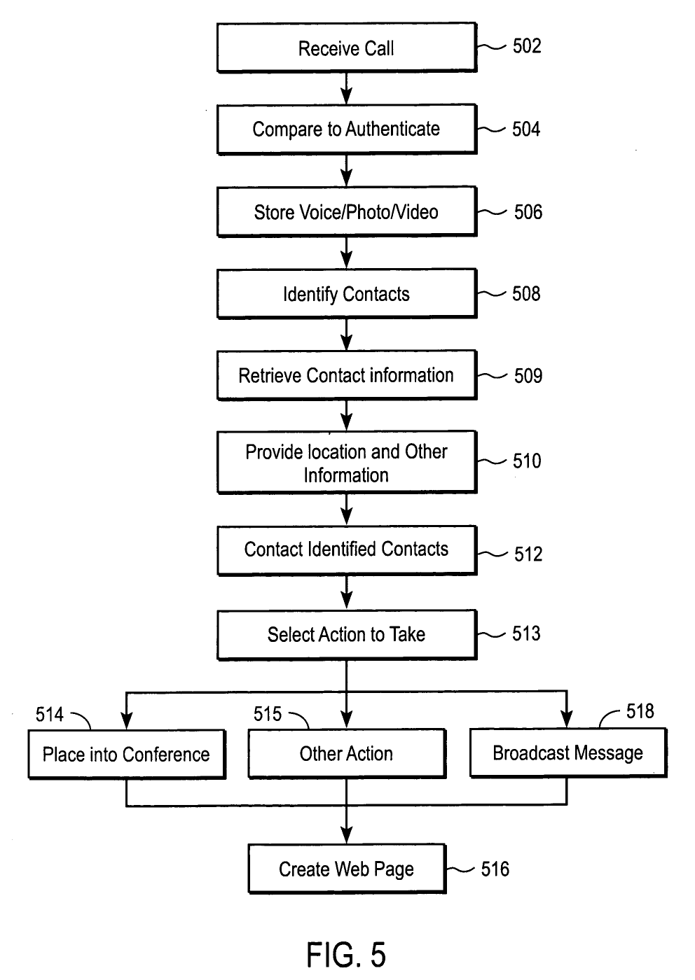

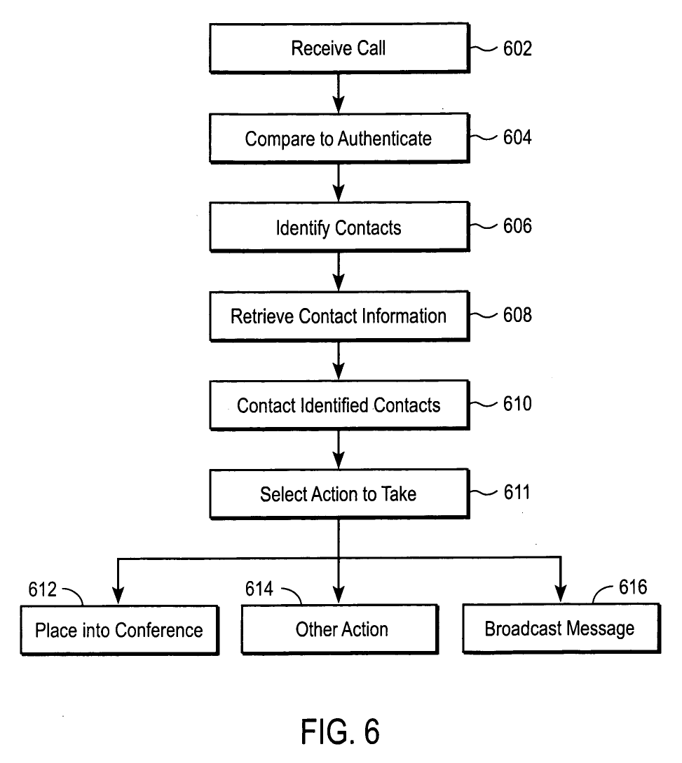

Referring now to FIG. 4, there is shown a flowchart illustrating the process by which a user signs up to use a service associated with the system 100, according to some embodiments of the present invention. Different embodiments of system 100 may perform the illustrated steps in different orders, omit certain steps, and/or perform additional steps not shown in FIG. 4 (the same is true for FIGS. 5 and 6).

In the embodiment illustrated in FIG. 4, a user can register 402 for a notification and broadcasting service associated with system 100. In some embodiments, the user can sign up via an application, via a web service, or other methods. In some embodiments, the user signs up via a web browser (e.g., on a PC, phone, PDA, etc.) by entering in personal identification information for the user into a webpage. In some embodiments, the user selects a user name and a password. In some embodiments, where the user is required to pay for the service, the user enters credit card or other financial information into the webpage. The user can also register one or more devices (e.g., a mobile phone, home phone, etc.) that the user will use to contact others through the system 100. In some embodiments, the user can associate this device with a specific name (e.g., the user's name) or if it is a shared device, with a few names or a group (e.g., the Smith Kids).

As illustrated in FIG. 4, the user can prepare 404 a contact list or contact groups. As one example, the user can provide a list of emergency contacts who live or work near the user, and can rush to the user's aid if necessary. As another example, the user can provide non-emergency contacts that the user might want to reach (e.g., teams of persons at work, groups of friends, etc.). Each user can have multiple contacts. The user can provide 406 contact information for his/her contacts., which can be stored in database 250. As described above, the file for each of these contacts can include many connection points (e.g., a home, work, or mobile number (including an IP-to-Text extension), a fax number, an email address, an IM address, etc.). In some embodiments, the contact information may be uploaded from most standard e-mail programs or from mobile phones or PDAs that can be connected to the Internet. In some embodiments, the system 100 is designed so that users can send (e.g., via e-mail) a “fill in the blank” form to the individuals in their contact list. The contacts could complete this information and return it to the user to input and/or this could automatically be recognized by the database 250 if forwarded to the host system 104. Contacts can be added, deleted, or modified at any time by the user via the Internet.

In some embodiments, the user can optionally indicate 408 time of day and/or day of week that certain contacts or groups of contacts should be reached. In some embodiments, a verification 410 process is conducted whereby the system 100 verifies contact information provided to ensure the phone numbers, e-mail addresses, etc. are active. The system 100 can also be designed to allow user to have voice options, if desired. For users with voice options, the user can do a voice recording 412 of his/her name (e.g., as the user would do for voice mail) via the Internet, by phoning into the host system 104 to do so, and so forth. Thus, a voice alert message can be played to contacts which will include the user's name from this recorded file.

In some embodiments, when a user has finished entering contact data, etc., he/she can indicate 414 that this is complete (e.g., via the Internet, by e-mail, by phone, etc.). In some embodiments, the system 100 is designed to initially contact all contacts identified by the user (e.g., by generating an e-mail, text message, by phone, etc., or any combination of these). For example, the system 100 might send an e-mail to all contacts and the e-mail can appear to come from the user. The e-mail can inform the contacts that they have been added to the user's contact list, and can explain how the system 100 works.

An activation/testing 416 phase can also occur once the contact information has been entered. For example, there can be an optional test in which the user loads a test number (e.g., a home number) into the user's registered device (e.g., user's mobile phone) as a speed dial number. Then, the user can practice pressing the speed dial key until the user can automatically find the key and make his/her test number ring without looking. Another test can be conducted in which the user loads the host system's 104 number into the speed dial for the registered device. The user can again practice pressing the speed dial number to call the host system 104. Thus, the user can verify that the practice calls to the host system 104 connect via the Internet. Another test the user can conduct is to practice giving pertinent information in the first ten seconds after the user presses the speed dial number. The user can practice giving location, describing specifics about the user's situation (e.g., in an emergency), and so forth. In some embodiments, the user can replay what he/she said and learn how much can be said in a period of time. As still another test, the user can indicate that he/she is conducting a live test via the Internet, and then can press the speed dial number to call the host system 104. In this test, the user's contacts can be sent a message for that user via every connection point provided to confirm that the system 100 works and the contacts are correctly reached. Upon completion of any tests required by the system 100 or desired by the user (if any are required or desired), the system 100 can be activated 416 for the user. As new contacts are added or modified, these contacts can also receive an initial e-mail or other form of contact and may also go through some testing 416 (e.g., receiving test message or call), as described above.

Referring now to FIG. 5, there is shown a flowchart illustrating the operation of the system 100 in contacting the user's contacts in the context of an emergency, according to some embodiments of the present invention. In an emergency situation, a user can contact the host system 104 (e.g., by pressing a speed dial number on a phone to call the host system's 104 emergency number). The host system 104 thus receives 502 a call from a caller 104 attempting to reach the plurality of contacts. The system can be designed so that no operator comes onto the line and the caller 104 does not have to experience the delay of being asked questions. In addition, the caller 102 may need to be quiet in an emergency. Simply by calling this number, the caller 102 can activate the emergency response system. The host system 104 can compare 504 an identifier associated with the caller 104 to identifiers stored in a database 250 to authenticate identity of the caller 102. As described above, the host system 104 can also compare an identifier that is automatically associated with the caller 102 (e.g., caller 102 does not have to type in a password or PIN number, but instead the host system 104 automatically recognizes who the caller is). For example, the authentication module 204 can use caller ID or automatic number ID (identifiers that are automatically associated with the caller 102) to recognize the caller 102 and then can compare this number to a collection of registered numbers stored in the database 250. Thus, the alarm can be silent if needed.

In some embodiments, to prevent false alarms, the system 100 can be designed so the caller 102 can select either a two button option involving two buttons on the caller's phone (e.g., the alert is only sent if the user presses a second button to confirm the alert after pressing the first, or the user presses two particular buttons at the same time, or other similar methods) or a PIN-activated option (e.g., the alert is only sent if the user enters the correct PIN upon placing the call), or other identifier.

In some embodiments, the caller 102 may have the ability to take a photo during the emergency that can be stored 506 by the system 100. In situations where a user feels threatened and he/she has a camera option on their device (e.g., a mobile phone), the user can snap a picture of the possible attacker, of the location where the user is, of any identifying information, such as a vehicle license number, and anything else for which the user thinks a photo might be useful. In some embodiments of the system 100, the user can then text (SMS) the photo(s) to the host system 104 (e.g., via a separate host system 104 number for receiving photos). The host system 104 can then store the photo(s) for later use, if needed. The user may also send digital pictures via the Internet to the host system 104 for storage. In some embodiments, the caller 102 can warn the attacker that the caller has taken his photo, which is now stored on a secure server where it can easily be provided to law enforcement. In some embodiments, the caller 102 can record video that is then uploaded to the host system 104 and stored 506 (e.g., in database 250). In some embodiments, the photo or video files, etc. can be mapped to the stored information associated with the caller 102 (e.g., any voice recordings or location information associated with the caller 102).

In some embodiments, the system 100 is designed so that the caller 102 can record voice that can be stored 506 (e.g., as an MP3 file, etc.) and mapped to other information associated with the call 201. For example, the caller's 102 entire call can be digitally recorded and may be provided to police or other law enforcement personnel. In some embodiments, the caller 102 can immediately press the speaker phone option on his/her phone (if available) to record events surrounding the emergency through the host system 104. In some embodiments, during the first ten seconds or so after a caller 102 calls the host system 104, if the caller 102 is able to speak, the caller 102 can state firmly and loudly his/her location, who he or she is with if known, describe what is happening, etc. (e.g., “It's Jane. I'm in the park by school. It's that creepy guy with the blue pickup.”). In some embodiments, the first ten seconds of the recording is added to the outgoing message to all of the contacts. The use of the voice recording option can prove and date-stamp non-consent where a caller 102 is being attacked or otherwise bothered in an unwanted manner.

The system 100 also identifies 508 which group of contacts on a contact list should be reached based on information provided by the caller 102 (e.g., information provided in advance, as described above). As described above, callers 102 have the option to set up multiple alert groups (e.g., a group in which everyone identified is alerted, a group that is a subset of just a few close friends or family members for less threatening situations, etc.). In some embodiments, the system 100 retrieves 509 contact information from database 250 for each of the identified contacts. If location tracking is enabled for the caller 102, the caller's pointpoly can be ascertained, which then stores and provides 510 the street location that the caller 102 is currently at and any other location information that can be ascertained. In some embodiments, where possible, this information is provided 510 in local map format in sufficient detail for contacts in the area to quickly know where the caller 102 is at and respond. In some embodiments, a map file is sent to the contacts' mobile phones, is included in e-mail messages, etc. The global positioning system (GPS) coordinates of a person can be determined and can be provided 510 to the contacts and to the emergency dispatch.

In some embodiments, the system 100 includes a child registry, into which a user can enter information about the user's children (e.g., name, age, photos, physical description, etc.). If the caller 102 has entered data into the child registry, this information can also be immediately provided to local authorities such as the police, the local media, the Amber Alert system, etc.

The host system 104 can then contact 512 the group identified contacts and can select 513 an action to take from a one or more actions, wherein the action to take is selected based on the identifier. As described above, the system 100 can use the identifier (e.g., the caller's 102 phone number) to determine what action should be performed. Using the identifier, the system 100 might determine that it should broadcast 518 a message to the contacts, place 514 the caller 102 into conference with the contacts, or perform some other action 515 (e.g., send an e-mail, etc.). In some embodiments, an emergency alert message is sent to all of contacts via some or all of their connection points. The host system 104 can generate multiple simultaneous SMS, e-mail, IM messages, phone calls, etc. This alert message can include the name of the subscriber, the ten second recording (or transcript of the recording), the street location of the subscriber (if location tracking is activated), and other relevant information. This message can be sent from the host system's 104 emergency response phone number. The police or other emergency services may also be contacted 512 at this time by the host system 104. In some embodiments, the contacts also receive instructions to call back the host system 104 using the emergency response phone number and the contacts can be given a code for the Internet via email, text, etc. If the caller 102 needs to remain silent, a silent alert can send out a standard alert message to the caller's 102 contact group stating that the caller 102 is in trouble and needs immediate help.

In the embodiment where the caller 102 should be placed 514 into conference with the contacts and the system 100 unsuccessfully tries to reach a contact (e.g., and possibly leaves a voice message for the contact), the contact can call back the system 100. If the contact uses a contact number that had been dialed by the host system 104 to contact that person, the host system 104 can automatically recognize that number and connect the contact to a conference call to help him/her organize the rescue of the caller 102. If the contact calls back from a different number, the contact can use the code sent to him/her for authentication purposes. On a conference call, contacts may be able to listen in (but may not be able to talk) to the caller's call if it is still active or they may play back the recording at their option. If possible, a caller 102 can stay on the line and be connected to a conference call with all his/her contacts. The caller 102 can get aid from those closest and able to help fast.

In some embodiments, the system 100 can create 516 a webpage associated with the emergency. For example, there can be an emergency response web page or blog to aid in the rescue. This webpage can include location information, mapping, stored photos of the caller 102, etc. Transcripts of anything recorded on the user's call to the host system 104 can also be made available to the contacts via the Internet. A follow-up webpage can also be available for callers 102. Callers 102 can be requested to provide information on their emergency calls made. This information can be accumulated and used to assist law enforcement officials or enhance the service offerings associated with the system 100.

Referring now to FIG. 6, there is shown a flowchart illustrating the operation of the system 100 in contacting the user's contacts in the context of a non-emergency situation, according to some embodiments of the present invention. The system 100 can receive 602 a call from a caller 102 attempting to reach the plurality of contacts (e.g., a team of co-workers, a group of friends, etc.). As described above, the system 100 can compare 604 an identifier associated with the caller 192 to identifiers stored in a database 250 to authenticate identity of the caller 102. The system 100 can also compare an identifier that is automatically associated with the caller 102 (e.g., the caller's phone number). Thus, the caller 102 does not have to type in a password or PIN number. Responsive to a positive authentication of the identity of the caller 102, the system 100 can identify 604 which contacts on a contact list are to be reached based on information provided by the caller 102 (e.g., information previously provided upon registration regarding groups of contacts, who to call when, etc.). As described above, the caller 102 might identify (by pressing a particular button, typing in a code, saying a name, etc.) a work team that the caller 102 would like to reach. In some embodiments, the system 100 retrieves 608 contact information for the identified contacts (e.g., retrieves the work phone numbers for everyone on the identified team). The system 100 can contact 610 the identified group of contacts and selects 611 a particular action to take based on the identifier associated with the caller 102. For example, the system 100 can broadcast 616 a message to the identified contacts, can place 612 the caller 102 into contact with the identified group of contacts through a conference call, or can perform some other action 614 (e.g., sending a fax, a text message, an e-mail, etc.).

In general with regard to the conferencing 514, 612 in either an emergency or non-emergency context, the system 100 is designed so that the caller 102 does not need to speak to an operator upon making a call to the host system 104. Instead, the arrangement of the conference call is automatic and can be “on the fly” (or real time). Thus, when the caller 102 calls the host system 104, the user is immediately placed into conference with the contacts. If one of the contacts is not available at the time, this contact can be sent a voice message, e-mail, etc. indicating that he/she should join the call when available. When the contact returns to his/her desk and receives the message, the contact can call the provided conference number to join the call. The contact would not need an identification number or PIN/code/etc. as is commonly required for conference calls since the system 100 can authenticate the contact via the contact's phone number (e.g., using caller ID). In some embodiments, contacts must simply enter a number to join the conference. In some embodiments, contacts notified by e-mail, text message, IM, etc. are given the number to use for calling into the in-progress conference call. The number to call can be uniquely identified with a recent notification event to route the contact to a unique queue. The contact can be identified by his/her phone number, via caller ID, automatic number identification, or other method to route to the appropriate callback queue. In some embodiments, the contact is given a code to be entered to determine the appropriate callback queue. For contacts notified by phone or other voice-enabled method, or given a call to a callback queue, the system 100 may perform a number of actions from a configured set of actions, including the following: 1) playing a message of instructions and allowing the contact to select from additional actions, 2) playing the previously recorded message from the original call, 3) playing a predefined message, 4) getting the location of the original caller, 5) getting directions to the location of the original caller, 6) allowing contact to join in a phone conference, and so forth.

In some embodiments, the members of the conference call can perform standard conference call actions, including muting/unmuting the call, attendee count, name announce, roll call, etc. In addition, with the conference call, the user may select to move to sub-conferences (e.g., task groups, search parties, etc.). Within a sub-conference, users can rejoin the main conference or switch to sub-conferences. In some embodiments, users may send a broadcast message to the main conference and all sub-conferences. There can also be a website associated with the call that can include pictures sent by the caller 102, the location and/or directions to the caller 102, a callback number to join the conference, a web log, a chat forum, etc.

While certain features and embodiments are discussed in relation to the emergency call embodiment of FIG. 5 and the non-emergency embodiment of FIG. 6, any of these features or embodiments can be interchangeable between the two examples.

Further, the features and advantages described in the specification provide a beneficial use to those making use of a system and a method as described in embodiments herein. For example, a user is provided mechanisms, e.g., by receiving and/or transmitting control signals, to control access to particular information as described herein. Further, these benefits accrue regardless of whether all or portions of components, e.g., server systems, to support their functionality are located locally or remotely relative to the user.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As will be understood by those familiar with the art, the invention may be embodied in other specific forms without departing from the spirit or essential characteristics thereof. Likewise, the particular naming and division of the modules, managers, features, attributes, methodologies and other aspects are not mandatory or significant, and the mechanisms that implement the invention or its features may have different names, divisions and/or formats. Furthermore, as will be apparent to one of ordinary skill in the relevant art, the modules, managers, features, attributes, methodologies and other aspects of the invention can be implemented as software, hardware, firmware or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment. Accordingly, the disclosure of the present invention is intended to be illustrative, but not limiting, of the scope of the invention, which is set forth in the following claims.

We claim:

1. A method for contacting a plurality of contacts, the method comprising:
receiving a call from a caller attempting to reach the plurality of contacts;
comparing an identifier automatically associated with the caller to identifiers stored in a database to authenticate identity of the caller;
responsive to a positive authentication of the identity of the caller, identifying which group of contacts on a contact list to be reached based on information provided by the caller;
contacting the identified group of contacts; and
selecting an action to take from one or more actions, wherein the action to take is selected based on the identifier.

2. The method of claim 1, wherein the identifier is the caller's phone number identified by caller identification.

3. The method of claim 1, wherein the identifier is the caller's phone number identified by automatic number identification

4. The method of claim 1, wherein identifying which group of contacts to be reached further comprises identifying based on a set of rules the group of contacts on the contact list to be reached based on time of day or day of week.

5. The method of claim 1, wherein the contact list is a list of one or more groups of persons that the caller has previously identified to be contacted.

6. The method of claim 5, wherein the list of one or more groups of persons is a list of emergency contacts that the caller has previously identified to be alerted in an emergency situation

7. The method of claim 1, wherein the action selected is taken in 30 seconds or less from when the call was received.

8. The method of claim 1, further comprising retrieving contact information for identified contacts from the database.

9. The method of claim 1, further comprising storing a sound recording recorded by the caller.

10. The method of claim 1, further comprising storing a photo taken by the caller.

11. The method of claim 1, further comprising storing a video taken by the caller.

12. The method of claim 1, further comprising providing location information for the caller to the identified group of contacts.

13. The method of claim 1, wherein the action selected is broadcasting a message to the identified group of contacts.

14. The method of claim 1, wherein the action selected is arranging a conference between the caller and the identified group of contacts.

15. The method of claim 14, further comprising placing the caller into contact with the identified group of contacts through a conference call.

16. The method of claim 1, wherein the caller is registered for a service for contacting a plurality of contacts, and the caller provides in advance contact information associated with the contacts.

17. A system for contacting a plurality of contacts, the system comprising:
a receiving module for receiving a call from a caller attempting to reach the plurality of contacts;
an authentication module for comparing an identifier automatically associated with the caller to identifiers stored in a database to authenticate identity of the caller;
an identification module for identifying which group of contacts on a contact list to be reached based on information provided by the caller, wherein the identification occurs responsive to a positive authentication of the identity of the caller;
a contact module for contacting the identified group of contacts; and
an action selection module for selecting an action to take from one or more actions, wherein the action to take is selected based on the identifier.

18. The system of claim 17, wherein the identifier is the caller's phone number identified by caller identification.

19. The system of claim 17, wherein the identifier is the caller's phone number identified by automatic number identification.

20. The system of claim 17, wherein the contact list is a list of one or more groups of persons that the caller has previously identified to be contacted.

21. The system of claim 20, wherein the list of one or more groups of persons is a list of emergency contacts that the caller has previously identified to be alerted in an emergency situation

22. The system of claim 17, further comprising a retrieval module for retrieving contact information for identified contacts from the database.

23. The system of claim 17, wherein the information provided by the caller includes identified groups of contacts to be contacted at certain times of day.

24. The system of claim 17, wherein the information provided by the caller includes identified groups of contacts to be contacted on certain days of week.

25. The system of claim 17, wherein the information provided by the caller includes identified groups of contacts with whom the caller wishes to speak simultaneously.

26. The system of claim 17, wherein the action selected is broadcasting a message to the identified group of contacts.

27. The system of claim 17, wherein the action selected is arranging a conference between the caller and the identified group of contacts.

28. The system of claim 28, further comprising a conferencing module for placing the caller into contact with the identified group of contacts through a conference call.

29. The system of claim 28, wherein the conferencing module is further adapted to leave a message for unavailable contacts through which the unavailable contacts can join the conference call after it has begun without requiring entry of an identification number.

30. A system for contacting a plurality of contacts, the system comprising:
means for receiving a call from a caller attempting to reach the plurality of contacts;
means for comparing an identifier automatically associated with the caller to identifiers stored in a database to authenticate identity of the caller;
means for identifying which group of contacts on a contact list to be reached based on information provided by the caller, wherein the identification occurs responsive to a positive authentication of the identity of the caller;
means for contacting the identified plurality of contacts; and
means for selecting an action to take from one or more actions, wherein the action to take is selected based on the identifier.

31. The system of claim 30, wherein the identifier is the caller's phone number identified by caller identification.

32. The system of claim 30, wherein the identifier is the caller's phone number identified by automatic number identification.

33. The system of claim 30, wherein means for placing the caller into contact is automated and is adapted to place the caller into contact with the identified group of contacts automatically, without requiring the caller to speak to an operator.

34. The system of claim 30, wherein the contact list is a list of one or more groups of persons that the caller has previously identified to be contacted.

35. The system of claim 34, wherein the list of one or more groups of persons is a list of emergency contacts that the caller has previously identified to be alerted in an emergency situation

36. The system of claim 30, further comprising a means for retrieving contact information for identified contacts from the database.

37. The system of claim 30, wherein the means for receiving a call is adapted to receive a call from any phone used by the caller and wherein the means for contacting is adapted for contacting the identified group of contacts on any phone used by the contacts.

38. The system of claim 30, wherein the action selected is broadcasting a message to the identified group of contacts.

39. The system of claim 30, wherein the action selected is arranging a conference between the caller and the identified group of contacts.

40. The system of claim 39, further comprising a means for placing the caller into contact with the identified plurality of contacts through a conference call
